(19) United States
(12) Patent Application Publication
(10) Pub. No.: US 2026/0261441 A1
(43) Pub. Date: Sep. 3, 2026

(54) Method for Implementing IoT Registration and System therefor

(71) Applicant: Feitian Technologies Co., Ltd., Beijing (CN)

(72) Inventors: Baohua MA, Beijing (CN); Zhou LU, Beijing (CN)

(21) Appl. No.: 18/878,928

(22) PCT Filed: Oct. 16, 2023
(86) PCT No.: PCT/CN2023/124728

§ 371 Date: Dec. 26, 2024

(30) Foreign Application Priority Data
Jul. 11, 2023 (CN) 202310841089.3

(51) Int. Cl. H04L 9/40; H04L 9/08; H04L 9/32; H04L 67/54; H04L 67/55

(52) U.S. Cl. CPC H04L 9/40; H04L 9/0825; H04L 9/0866; H04L 9/3236; H04L 9/3247; H04L 67/54; H04L 67/55

(57) ABSTRACT

A method for implementing an IoT registration, which includes a push service registration process and a terminal device registration process. The former includes: an authentication center receives a registration request sent by a push service and returns a registration response to the push service; the authentication center, after verifying an identity authentication request sent by the push service successfully, saves protocol data in the identity authentication request in correspondence with device identification, and returns push service timeout time within a preset range to the push service for saving. The latter includes: the authentication center receives a loading request sent by the terminal device and returns a loading request response to the terminal device; the authentication center returns an address of the push service to the terminal device after successfully verifying a received identity authentication request sent by the terminal device, and the terminal device saves the address of the push service in correspondence with the device identification. According to the present invention, the security of the IoT entire chain can be enhanced.

### FIELD OF THE INVENTION

The present invention relates to a method for implementing an IoT registration and a system therefor, and belongs to the field of information security technology.

### PRIOR ART

The Internet of Things (IoT) develops at a high speed and its security solution currently lacks a uniform and professional industry standard and specification. With today's high-speed development of IoT a very large number of cloud service vendors emerge, and most vendors perform security protocols through customized implementation solutions that do not have a uniform standard for their security and integrity, thus are not readily accepted by the market. More importantly, most of the current cloud services are implemented via the intersection of business and security, and cannot be split and separated even if private deployment is performed, resulting in significant inconvenience in use, and compromised security for device registration and service registration. Therefore, there is an urgent need to provide a secure, reliable and convenient registration method.

### SUMMARY OF THE INVENTION

An object of the present invention is to provide a method for implementing an IoT registration and a system therefor to improve its security.

According to the first aspect of the present invention, there is provided a method for implementing an IoT registration, including: a push service registration process and a terminal device registration process. The push service registration process includes:
Step S1: generating, by a push service, a registration request according to a device identification of a terminal device that needs to be registered, corresponding device attribution information and a push service public key, and sending the registration request to an authentication center, wherein the device attribution information includes a device public key, identity information of the push service, and an address of the push service;
Step S2: saving, by the authentication center, the device identification, the corresponding device attribution information and the push service public key in the received registration request, generating a first nonce, and generating a registration response according to the device identification in the registration request and the first nonce, then returning the registration response to the push service;
Step S3: parsing, by the push service, the received registration response, generating protocol data according to the device attribution information, the first nonce obtained by parsing, and preset push service timeout time, generating an identity authentication request according to the protocol data, and sending the identity authentication request to the authentication center;
Step S4: verifying, by the authentication center, the identity authentication request according to the push service public key, saving the protocol data in the identity authentication request in correspondence with the device identification if the verification succeeds, and executing Step S5;
Step S5: determining, by the authentication center, whether the push service timeout time in the identity authentication request is within a preset range, if yes, executing Step S6, otherwise, generating push service timeout time within the preset range, then executing Step S6;
Step S6: generating, by the authentication center, an identity authentication response according to the push service timeout time and returning the identity authentication response to the push service; and
Step S7: saving, by the push service, the push service timeout time in the identity authentication response.

The terminal device registration process includes:
Step T1: generating, by the terminal device, a loading request according to the device identification and sending the loading request to the authentication center;
Step T2: determining, by the authentication center, whether corresponding protocol data is saved according to the device identification in the loading request, if yes, executing Step T3, otherwise, returning error information to the terminal device;
Step T3: generating, by the authentication center, a second nonce, saving the second nonce in correspondence with the device identification, generating a loading request response according to the second nonce, and returning the loading request response to the terminal device;
Step T4: parsing, by the terminal device, the received loading request response, generating an identity authentication request according to a second nonce obtained by parsing, the device identification and a device private key, and sending the identity authentication request to the authentication center;
Step T5: verifying, by the authentication center, the identity authentication request according to a device public key in the saved protocol data and the second nonce, if the verification succeeds, generating an identity authentication request response according to an address of the push service in the saved protocol data, returning the identity authentication request response to the terminal device, and executing Step T6; if the verification fails, returning error information to the terminal device; and
Step T6: parsing, by the terminal device, the identity authentication request response to obtain the address of the push service, and saving the address of the push service in correspondence with the device identification.

According to the second aspect of the present invention, there is provided a system for implementing an IoT registration, which includes a push service, a terminal device and an authentication center, and is used for implementing the aforementioned method for implementing the IoT registration.

According to the third aspect of the present invention, there is provided an electronic device including at least one processor, a memory, and instructions stored on the memory and executable by the at least one processor, wherein the at least one processor executes the instructions to implement the aforementioned method for implementing the IoT registration.

According to the fourth aspect of the present invention, there is provided a computer readable storage medium including a computer program which, when executed, implements the aforementioned method for implementing the IoT registration.

According to the fifth aspect of the present invention, there is provided a chip that is coupled to a memory for executing a computer program stored in the memory to perform the aforementioned method for implementing the IoT registration.

According to the present invention, the terminal device registration, the push service registration, and business processing are separated from each other, and are independent, thus ensuring security and convenience.

According to the present invention, the authentication center authenticates the push service and the terminal device separately, and business communication between the push service and the terminal device can only proceed after both the push service and the terminal device have successfully registered, thereby enhancing the security of the entire chain of the Internet of Things.

### BRIEF DESCRIPTION OF THE DRAWINGS

FIG. 1 is a flowchart of a push service registration process in a method for implementing IoT registration according to Embodiment 1 of the present invention;

FIG. 2 is a flowchart of a device registration process in a method for implementing IoT registration according to Embodiment 1 of the present invention;

FIG. 3 is a flowchart of a push service registration process in a method for implementing IoT registration according to Embodiment 2 of the present invention;

FIG. 4 is a flowchart of a device registration process in a method for implementing IoT registration according to Embodiment 2 of the present invention.

### DETAILED DESCRIPTION OF PREFERRED EMBODIMENTS

The present invention proposes a method for implementing an IoT registration and a system therefor, and specific embodiments of the present invention will be described in detail with reference to the accompanying drawings. The embodiments described below with reference to the accompanying drawings are exemplary, only for explaining the present invention, and cannot be construed as limitations on the present invention.

It may be understood by those skilled in the art that, unless otherwise defined, all terms (including technical and scientific terms) used herein have the same meaning as commonly understood by those skilled in the art. It may be further understood that terms, such as those defined in general dictionaries, should be interpreted as having the meanings that are consistent with their meanings in the context of the prior art and will not be interpreted in an idealized or overly formal sense unless specifically defined as herein.

In order to further clarify the objects, technical solutions and advantages of the present invention clear, the implementations of the present invention will be further described in detail below with reference to the accompanying drawings.

### Embodiment 1

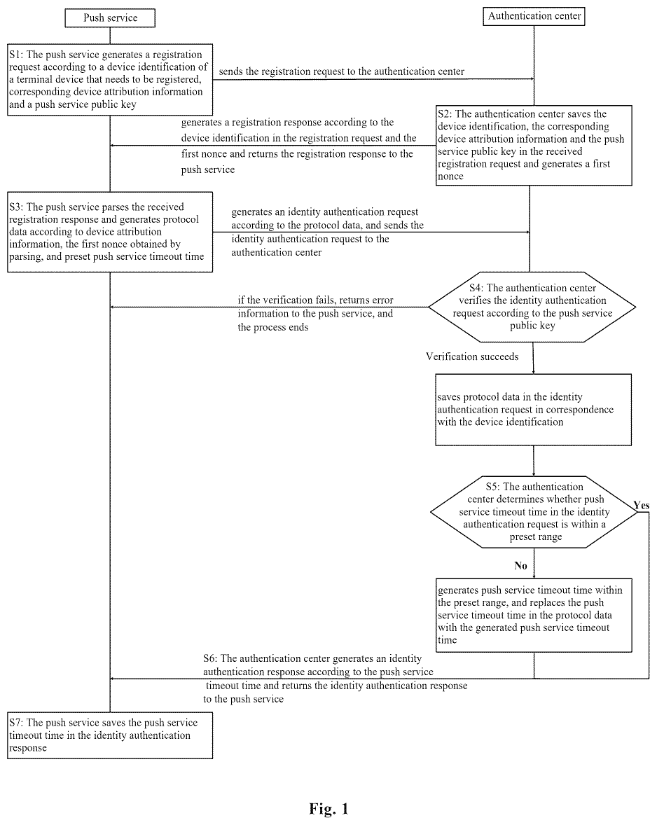

Embodiment 1 of the present invention provides a method for implementing an IoT registration, including a push service registration process and a terminal device registration process. The push service registration process, as shown in FIG. 1, includes the following steps.
Step S1: a push service generates a registration request according to a device identification of a terminal device that needs to be registered, corresponding device attribution information and a push service public key, and sends the registration request to an authentication center.

In Embodiment 1, the device attribution information includes a device public key, identity information of the push service and an address of the push service.

Preferably, in this embodiment, before Step S1, the push service registration process further includes:
the push service inquires whether a terminal device that needs to be registered exists in a target device database managed by the push service; if yes, executes Step S1, otherwise, waits to receive a terminal device connection request, wherein the terminal device that needs to be registered includes a terminal device that has not been connected to the push service, or a terminal device whose connection time with the push service exceeds preset push service timeout time.
Step S2: the authentication center saves the device identification, the corresponding device attribution information and the push service public key in the received registration request, generates a first nonce, and generates a registration response according to the device identification in the registration request and the first nonce, then returns the registration response to the push service.
Step S3: the push service parses the received registration response, generates protocol data according to the device attribution information, the first nonce obtained by parsing, preset push service timeout time, generates an identity authentication request according to the protocol data, and sends the identity authentication request to the authentication center;
in Embodiment 1, the protocol data includes first protocol data and second protocol data.

Specifically, Step S3 includes: the push service parses the received registration response to obtain the device identification and the first nonce, generates first protocol data according to device attribution information corresponding to the device identification, the first nonce, and the preset push service timeout time, calculates a hash value of the first protocol data, generates valid data according to the hash value of the first protocol data and the address of the push service, signs the valid data using a push service private key to obtain signing data, generates second protocol data according to the valid data and the signing data, generates an identity authentication request according to the first protocol data and the second protocol data, and sends the identity authentication request to the authentication center.
Step S4: the authentication center verifies the identity authentication request according to the push service public key, saves the protocol data in the identity authentication request in correspondence with the device identification if the verification succeeds, executes Step S5, and returns error information to the push service if the verification fails; and the process ends.

Correspondingly, Step S4 in Embodiment 1 includes:
Step S41: the authentication center parses the received identity authentication request to obtain the first protocol data and the second protocol data;
Step S42: the authentication center performs a hash calculation on the first protocol data, and determines whether a calculated hash value is consistent with a hash value in valid data of the second protocol data; if yes, executes Step S43, otherwise, returns error information to the push service; the process ends;
Step S43: the authentication center verifies signing data in the second protocol data using the saved push service public key, and determines whether the verification passes; if yes, executes Step S44, otherwise, returns error information to the push service; the process ends; and
Step S44: the authentication center saves the first protocol data and the second protocol data in correspondence with the device identification.
Step S5: the authentication center determines whether the push service timeout time in the identity authentication request is within a preset range; if yes, executes Step S6, otherwise, generates push service timeout time within the preset range, and replaces the push service timeout time in the protocol data with the generated push service timeout time; executes Step S6;
Step S6: the authentication center generates an identity authentication response according to the push service timeout time and returns the identity authentication response to the push service; and
Step S7: the push service saves push service timeout time in the identity authentication response.

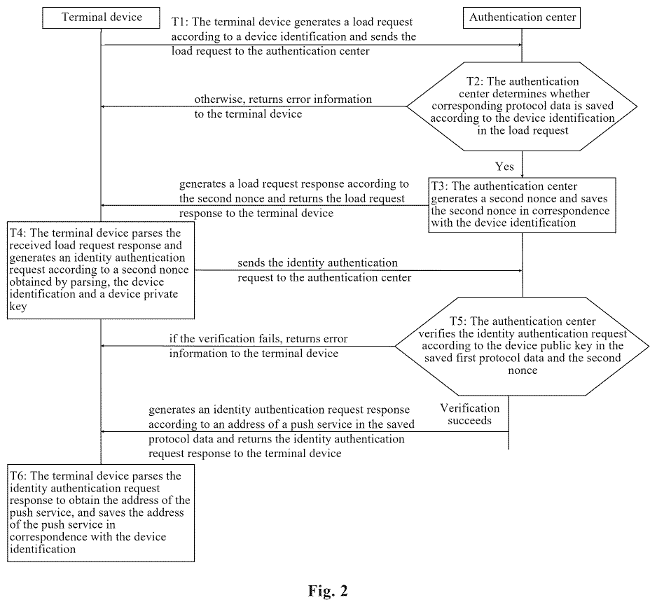

The device registration process in Embodiment 1, as shown in FIG. 2, includes the following steps.
Step T1: a terminal device generates a loading request according to a device identification and sends the loading request to an authentication center;
preferably, before Step T1 of Embodiment 1, the device registration process further includes: the terminal device acquires its own device state and determines whether the device state is a pre-loading state; if yes, Step T1 is executed.
Step T2: the authentication center determines whether corresponding protocol data is saved according to the device identification in the loading request; if yes, executes Step T3, otherwise, returns error information to the terminal device;

In Embodiment 1, the protocol data includes first protocol data and second protocol data;
preferably, the terminal device may repeatedly send the loading request to the authentication center, i.e., when it is determined in Step T2 that the result is no, the device registration process further includes: the terminal device, after receiving the error information, resets a timer, and resends the loading request to the authentication center when the timer reaches preset data, and executes Step T2.
Step T3: the authentication center generates a second nonce, saves the second nonce in correspondence with the device identification, generates a loading request response according to the second nonce, and returns the loading request response to the terminal device.
Step T4: the terminal device parses the received loading request response, generates an identity authentication request according to a second nonce obtained by parsing, the device identification and a device private key, and sends the identity authentication request to the authentication center;
specifically, in Embodiment 1, Step T4 includes: the terminal device parses the received loading request response to obtain a second nonce, generates first to-be-signed data according to the device identification and the second nonce, signs the first to-be-signed data using the device private key to obtain a first signing result, generates an identity authentication request according to the first to-be-signed data and the first signing result, and sends the identity authentication request to the authentication center.
Step T5: the authentication center verifies the identity authentication request according to the device public key in the saved first protocol data and a second nonce, if the verification succeeds, generates an identity authentication request response according to an address of a push service in the saved protocol data, and returns the identity authentication request response to the terminal device, and executes Step T6; if the verification fails, returns error information to the terminal device.

Correspondingly, Step T5 in Embodiment 1 includes:
Step T51: the authentication center parses the received identity authentication request, and acquires a corresponding second nonce saved according to the device identification obtained by parsing;
Step T52: the authentication center determines whether the second nonce obtained by parsing is consistent with the acquired second nonce; if yes, executes Step T53, otherwise returns error information to the terminal device; the process ends;
Step T53: the authentication center acquires the saved protocol data according to the device identification, acquires device attribution information in the protocol data, and verifies the first signing result in a parsing result using a device public key in the device attribution information; if the verification succeeds, executes Step T54, if the verification fails, returns error information to the terminal device; the process ends;
further, the authentication center acquires the saved first protocol data according to the device identification, and acquires device attribution information in the first protocol data.
Step T54: the authentication center acquires an address of the push service in the corresponding protocol data saved according to the device identification, generates an identity authentication request response according to the address of the push service, and returns the identity authentication request response to the terminal device.
Step T6: the terminal device parses the identity authentication request response to obtain the address of the push service and saves the address of the push service in correspondence with the device identification.

Preferably, in Embodiment 1, after Step T6 or when the device state of the terminal device is not a pre-loading state, the terminal device registration process further includes:
Step A1: a terminal device generates a connection request according to the device identification, sends the connection request to a corresponding push service according to an address of the push service in the second protocol data;
Step A2: the push service parses the received connection request and determines whether the device identification obtained by parsing exists in a target device database managed by the push service; if yes, executes Step A3, otherwise, returns error information to the terminal device; the process ends;
Step A3: the push service establishes a long connection with the terminal device, and returns a connection success response to the terminal device; and
Step A4: the terminal device, after receiving the connection success response, initiates business communication with the push service.

In Embodiment 1, terminal device registration, push service registration, and business processing are separated from each other and are independent, ensuring security and convenience. The authentication center in the technical solution authenticates the push service and the terminal device separately, and business communication between the push service and the terminal device can only proceed after both the push service and the terminal device have successfully registered, thereby enhancing the security of the entire chain of the Internet of Things.

### Embodiment 2

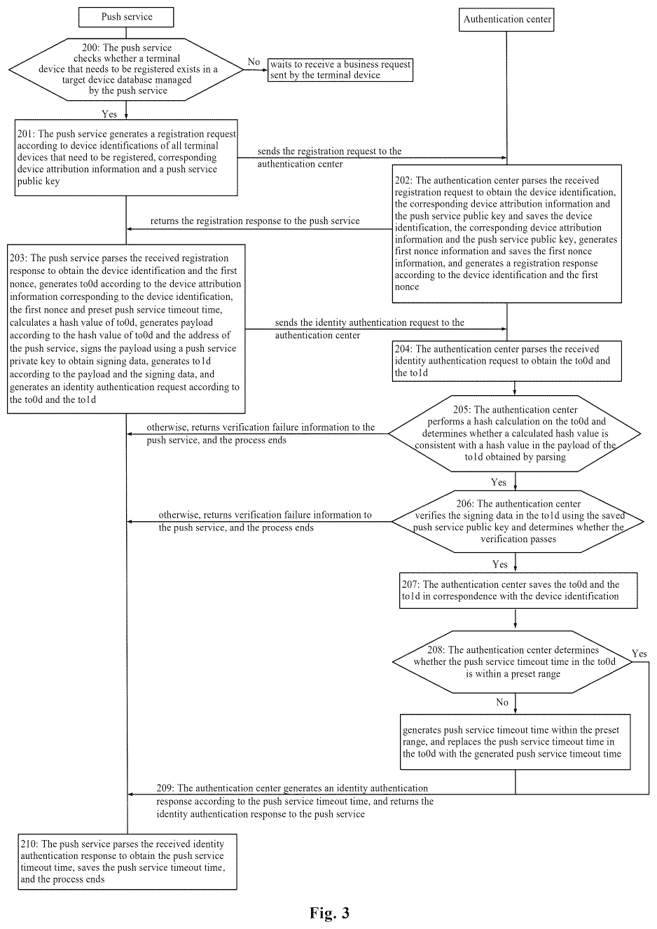

Embodiment 2 of the present invention provides a method for implementing an IoT registration, including a push service registration process and a device registration process, wherein the push service registration process, as shown in FIG. 3, includes the following steps.
Step 200: a push service checks whether a terminal device that needs to be registered exists in a target device database managed by the push service; if yes, executes Step 201, otherwise, waits to receive a business request sent by the terminal device.

Specifically, in Embodiment 2, Step 200 includes: the push service checks whether a terminal device that has not been connected to the push service exists in the target device database managed by the push service or determines whether a terminal device whose connection time with the push service exceeds preset push service timeout time exists; if yes, executes Step 201, otherwise, waits to receive a connection request sent by the terminal device.

In Embodiment 2, before Step 200, the push service registration process further includes: the push service receives device attribution information and device information of the terminal device input by a user and saves the device attribution information in correspondence with the device information, wherein the device attribution information and the device information are both from a manufacturing station, the device attribution information includes identity information of the push service and an address of the push service, and the device information includes a device identification and a device public key.
Step 201: the push service generates a registration request according to device identifications of all terminal devices that need to be registered, corresponding device attribution information and a push service public key, and sends the registration request to an authentication center.
Step 202: the authentication center parses the received registration request to obtain the device identification, the corresponding device attribution information and the push service public key and saves the device identification, the corresponding device attribution information and the push service public key, generates first nonce information and saves the first nonce information, generates a registration response according to the device identification and the first nonce, and returns the registration response to the push service.
Step 203: the push service parses the received registration response to obtain the device identification and the first nonce, generates to0d (transfer ownership protocol 0 data, referred to as first protocol data) according to the device attribution information corresponding to the device identification, the first nonce and preset push service timeout time, calculates a hash value of to0d, generates payload (valid data) according to the hash value of to0d and the address of the push service, signs the payload using a push service private key to obtain signing data, generates to1d (transfer ownership protocol 1 data, referred to as second protocol data) according to the payload and the signing data, generates an identity authentication request according to the to0d and the to1d, and sends the identity authentication request to the authentication center.

Preferably, Step 203 further includes: the push service saves the first nonce obtained by parsing.
Step 204: the authentication center parses the received identity authentication request to obtain the to0d and the to1d.

Further, in Step 204, the authentication center continues to parse the to1d to obtain the payload and the signing data, parses the payload to obtain an address and a hash value of the push service, and parses the to0d to obtain the device attribution information, the first nonce, and push service timeout time.

For example, the to0d and the to1d parsed in this step in this embodiment 2 are:

```
      { [symbol]
        “to0d”: { [symbol]
              “nonce”: { [symbol]
                  “nonce”: “E9XgCtzEStuei7KHguKddg==” [symbol]
              }, [symbol]
              “voucher”: { [symbol]
                  “certChain”: { [symbol]
      “chain”: [
                {
                    “issuerDN”: { }, [symbol]
                    “name”: “x509”, [symbol]
                    “publicKey”: {
                        “algorithm”: “EC”, [symbol]
                          “algorithmId”: { }, [symbol]
                          “encoded”:
  “MFkwEwYHKoZIzj0CAQYIKoZIzj0DAQcDQgAERrvV6N04EW5dJAxRsjROJn6O2z1hIjltCLzsY4fH4cdTN1FhyR7vJ [symbol] H0Fm5 [symbol] wt1fYVpvu90lo
  ktScFsdQOuEig==”, [symbol]
                          “encodedInternal”:
  “MFkwEwYHKoZIzj0CAQYIKoZIzj0DAQcDQgAERrvV6N04EW5dJAxRsjROJn6O2z1hIjltCLzsY4fH4cdTN1FhyR7vJlH0Fm5 [symbol] wt1fYVpvu90lo
  ktScFsdQOuEig==”, [symbol]
                          “encodedPublicValue”:
  “BEa71ejdOBFuXSQMUbI0TiZ+jts9YSI5bQi87GOHx+HHUzdRYcke7yZR9BZuZcLdX2Fab7vdJaJLUnBbHUDrhIo=”, [symbol]
                          “format”: “X.509”, [symbol]
                          “params”: [symbol] }, [symbol]
                          “w”: { }, [symbol]
                      }, [symbol]
                      “serialNumber”: 3674384926778672600, [symbol]
                      “serialNumberObject”: { }, [symbol]
                      “sigAlgName”: “SHA256withECDSA”, [symbol]
                      “sigAlgOID”: “1.2.840.10045.4.3.2”, [symbol]
                      “signature”:
  “MEUCIQC+BAxVBb9STKDWQUKc+C2bPKlJLS4PNnUI7EyZdJRNjAIgW/n0A÷7790ECO1Qc94qGvB8/5t48lMuj90u [symbol] yhx55LQ=”, [symbol]
                      “subjectDN”: { }, [symbol]
                      “tBSCertificate”:
  “MIHEoAMCAQICCDL+CZ+IsUXQMAoGCCqGSM49BAMCMBQxEjAQBgNVBAMMCUZkb0VudG [symbol] 0eTAgFw0yMjA3MjgwMTM0MzFaGA8
  yMDUyMDIyMTAxMzQzMVowFDESMBAGA [symbol] UEAwwJRmRvRW50aXR5MFkwEwYHKoZIzj0CAQYIKoZIzj0DAQcDQgAERrvV6N04EW5d
      JAxRsjROJn6O2z1hIjltCLzsY4fH4cdTN1FhyR7vJ [symbol] H0Fm5lwt1fYVpvu90loktScFsdQOuEig==”, [symbol]
                      “type”: “X.509”, [symbol]
                      “version”: 3 [symbol]
                }, [symbol]
                {
                      “issuerDN”: { }, [symbol]
                      “name”: “x509”, [symbol]
                      “publicKey”: { [symbol]
                        “algorithm”: “EC”, [symbol]
                        “algorithmId”: { }, [symbol]
                        “encoded”:
“MFkwEwYHKoZIzj0CAQYIKoZIzj0DAQcDQgAE7EM4Qh7KSxwTLQYyZMVPvd [symbol] kxqaBHboRKVs7tUJtwaGp4MwG3omcIXEUNVxm3TTp2
EX5woKX7Typw2mpzPXVDw==”, [symbol]
                        “encodedInternal”:
“MFkwEwYHKoZIzj0CAQYIKoZIzj0DAQcDQgAE7EM4Qh7KSxwTLQYyZMVPvd [symbol] kxqaBHboRKVs7tUJtwaGp4MwG3omcIXEUNVxm3TTp2
EX5woKX7Typw2mpzPXVDw==”, [symbol]
                        “encodedPublicValue”:
“BOxDQEleykscEy0GMmTFT73dZMamgR26ESlbO7VCbcGhqeDMBt6JnCFxFDVcZt006dhF+cKC [symbol] +08qcNpqcz11Q8=”, [symbol]
                        “format”: “X.509”, [symbol]
                        “params”: { }, [symbol]
                        “w”: { } [symbol]
                    },
                    “serialNumber”: 8027455762135928000, [symbol]
                    “serialNumberObject”: { }, [symbol]
                    “sigAlgName”: “SHA256withECDSA”, [symbol]
                    “sigAlgOID”: “1.2.840.10045.4.3.2”, [symbol]
                    “signature”:
“MEQCIEvW7f3sjiE18HnG5BKDc1ytRZkR6hZrszkpO6Vu1J4LAiAwDRYUz9HyeV [symbol] atc2Id4k [symbol] SKxRUPQVU [symbol] vBkrgGnuKLTA==”, [symbol]
                    “subjectDN”: { }, [symbol]
                    “tBSCertificate”:
“MIHEoAMCAQICCG9nQHwARkpWMAoGCCqGSM49BAMCMBQxEjAQBgNVBAMMCUZkb0VudGl0eTAgFw0yMjA3MjgwMTM0MzFaG
A8yMDUyMDIyMTAxMzQzMVowFDESMBAGA1UEAwwJRmRvRW50aXR5MFkwEwYHKoZIzj0CAQYIKoZIzj0DAQcDQgAE7EM4Qh7KS
xwTLQYyZMVPvd1kxqaBHboRKVs7tUJtwaGp4MwG3omcIXEUNVxm3TTp2EX5woKX7Typw2mpzPXVDw==”, [symbol]
                    “type”: “X.509”, [symbol]
                    “version”: 3 [symbol]
                } [symbol]
            ], [symbol]
            “path”: { [symbol]
                    ], [symbol]
                    “entries”:[{
                            “payload”:“hrKKPR9Sf2wyB7g=”, [symbol]
                            “protectedHeader”:“oQEm”, [symbol]
                            “signature”:“mhujAJoU2qzmYGzXz4Q==”, [symbol]
                            “tag”:“COSE_SIGN_1”, [symbol]
                            “unprotectedHeader”: [symbol]
                            } [symbol]
                          }], [symbol]
                    “header”: [symbol]
      “chain”: [ [symbol]
                  { [symbol]
                      “issuerDN”: [symbol]
                      “name”: “x509”, [symbol]
                      “publicKey”: { [symbol]
                          “algorithm”: “EC”, [symbol]
                          “algorithmId”: { }, [symbol]
                          “encoded”:
  “MFkwEwYHKoZIzj0CAQYIKoZIzj0DAQcDQgAERrvV6N04EW5dJAxRsjROJn6O2z1hIjltCLzsY4fH4cdTN1FhyR7vJlH0Fm5lwt [symbol] fYVpvu90lo
  ktScFsdQOuEig==”, [symbol]
                        “encodedInternal”:
“MFkwEwYHKoZIzi0CAQYIKoZIzj0DAQcDQgAERrvV6N04EW5dJAxRsjROJn6O2z1hIjltCLzsY4fH4cdTN1FhyR7vJlH0Fm5lwt [symbol] fYVpvu90lo
ktScFsdQOuEig==”, [symbol]
                        “encodedPublicValue”:
“BEa71ejdOBFuXSQMUbI0TiZ+jts9YSI5bQi87GOHx+HHUzdRYcke7yZR9BZuZcLdX2Fab7vdJaJLUnBbHUDrhIo=”, [symbol]
                        “format”: “X.509”, [symbol]
                        “params”: { }, [symbol]
                        “w”: { }, [symbol]
                      }, [symbol]
                      “serialNumber”: 3674384926778672600, [symbol]
                      “serialNumberObject”: [symbol]
                      “sigAlgName”: “SHA256withECDSA”, [symbol]
                      “sigAlgOID”: “1.2.840.10045.4.3.2”, [symbol]
                      “signature”:
  “MEUCIQC+BAxVBb9STKDWQUKc+C2bPKlJLS4PNnUI7EyZdJRNjAIgW/n0A+7790ECO [symbol] Qc94qGvB8/5t48 [symbol] Maj90u [symbol] yhx55LQ=”, [symbol]
                      “subjectDN”: { }, [symbol]
                      “tBSCertificate”:
  “MIHEoAMCAQICCDL+CZ+IsUXQMAoGCCqGSM49BAMCMBQxEjAQBgNVBAMMCUZkb0VudG [symbol] 0eTAgFw0yMjA3MigwMTM0MzFaGA8
  yMDUyMDIyMTAxMzQzMVowFDESMBAGA1UEAwwJRmRvRW50aXR5MFkwEwYHKoZIzj0CAQYIKoZIzj0DAQcDQgAERrvV6N04EW5d
  JAxRsjROJn6O2z1hIjltCLzsY4fH4cdTN1FhyR7vJ [symbol] H0Fm5lwt [symbol] fYVpvu90loktScFsdQOuEig==”, [symbol]
                      “type”: “X.509”, [symbol]
                      “version”: 3 [symbol]
                  }, [symbol]
                  { [symbol]
                      “issuerDN”: { }, [symbol]
                      “name”: “x509”, [symbol]
                      “publicKey”: { [symbol]
                          “algorithm”; “EC”, [symbol]
                          “algorithmId”: { }, [symbol]
                          “encoded”:
  “MFkwEwYHKoZIzj0CAQYIKoZIzj0DAQcDQgAE7EM4Qh7KSxwTLQYyZMVPvd1kxqaBHboRKVs7tUJtwaGp4MwG3omeIXEUNVxm3TTp2
  EX5woKX7Typw2mpzPXVDw==”, [symbol]
                          “encodedInternal”:
  “MFkwEwYHKoZIzj0CAQYIKoZIzj0DAQcDQgAE7EM4Qh7KSxwTLQYyZMVPvd1kxqaBHboRKVs7tUJtwaGp4MwG3omeIXEUNVxm3TTp2
  EX5woKX7Typw2mpzPXVDw==”, [symbol]
                          “encodedPublicValue”:
  “BOxDOEIeykscEy0GMmTFT73dZMamgR26ESlbO7VCbcGhqeDMBt6JnCFxFDVcZt006dhF+cKC [symbol] +08qcNpqez11Q8=”, [symbol]
                          “format”: “X.509”, [symbol]
                          “params”: { }, [symbol]
                          “w”:{ [symbol]
                      }, [symbol]
                      “serialNumber”: 8027455762135928000, [symbol]
                      “serialNumberObject”: { }, [symbol]
                      “sigAlgName”: “SHA256withECDSA”, [symbol]
                      “sigAlgOID”: “1.2.840.10045.4.3.2”, [symbol]
                      “signature”:
  “MEQCIEvW7f3sjiE18HnG5BKD [symbol] 1ytRZKR6hZrszkpO6Vu [symbol] J4LAiAwDRYUz9HyeV+ate2Id4klSKxRUPQVU1vBkrgGnuKLTA==”, [symbol]
                      “subjectDN”: { }, [symbol]
                      “tBSCertificate”:
  “MIHEoAMCAQICCG9nQHwARkpWMAoGCCqGSM49BAMCMBQxEjAQBgNVBAMMCUZkb0VudGl0eTAgFw0yMjA3MjgwMTM0MzFaG
  A8yMDUyMDIyMTAxMzQzMVowFDESMBAGA [symbol] UEAwwJRmRvRW50aXR5MFkwEwYHKoZIzj0CAQYIKoZIzj0DAQcDQgAE7EM4Qh7KS
  xwTLQYyZMVPvd [symbol] kxqaBHboRKVs7tUJtwaGp4MwG3omcIXEUNVxm3TTp2EXSwoKX7Typw2mpzPXVDw==”, [symbol]
                      “type”: “X.509”, [symbol]
                      “version”: 3 [symbol]
                  } [symbol]
          ], [symbol]
          “path”: { }} [symbol]
                  “hmac”: { [symbol]
                        “hashType”: “HMAC_SHA256”, [symbol]
                        “hashValue”: “Juczi [symbol] QtAlkrvi3JTpHFc/pqQ2V3HF+ufZdqMm/v0Vs=” [symbol]
                  }, [symbol]
                  “version”: “V101” [symbol]
          }, [symbol]
          “waitSeconds”: 86400 [symbol]
      }, [symbol]
      “told”: { [symbol]
            “payload”: { [symbol]
    “rendezvousInfo”: [{ [symbol]
          “value”: “aTEyNy4wLjAuMQ==”, [symbol]
          “variable”: “DNS” [symbol]
        }, { [symbol]
          “value”: “80”, [symbol]
          “variable”: “DEV_PORT” [symbol]
        }, { [symbol]
          “value”: “192.168.1.1”, [symbol]
          “variable”: “IP_ADDRESS” [symbol]
        }, { [symbol]
          “value”: “80”, [symbol]
          “variable”: “OWNER_PORT” [symbol]
        } { [symbol]
          “value”: “HTTPS”, [symbol]
          “variable”: “PROTOCOL” [symbol]
        }], [symbol]
    “hash”: { [symbol]
          “hashType”: “SHA256”, [symbol]
          “hashValue”: “/cgPU8g6VNx3SheH41HPSTSlgccuqEty/7B8cmpeO8w=” [symbol]
        } [symbol]
    }, [symbol]
            “protectedHeader”: “oQEm”,
            “signature”: “df0o5r3aFZ3OWXxVocbcUIQXQ3O0cx7oOQU7GK9vUcK0AzK90qW [symbol] x+w==”, [symbol]
              “tag”: “COSE_SIGN_1”, [symbol]
              “unprotectedHeader”: { } [symbol]
        } [symbol] [symbol]
indicates data missing or illegible when filed
```

Step 205: the authentication center performs a hash calculation on the to0d and determines whether a calculated hash value is consistent with a hash value in the payload of the to1d obtained by parsing; if yes, executes Step 206, otherwise, returns verification failure information to the push service, and the process ends.
Step 206: the authentication center verifies the signing data in the to1d using the saved push service public key, and determines whether the verification passes; if yes, executes Step 207, otherwise, returns verification failure information to the push service; the process ends.

Specifically, Step 206 includes: the authentication center performs a hash calculation on the payload in the to1d, decrypts the signing data in the to1d using the push service public key, and determines whether a result obtained by hash calculation and a result obtained by decryption are consistent; if yes, executes Step 207, otherwise, returns verification failure information to the push service; the process ends.

Step 207: the authentication center saves the to0d and to1d in correspondence with the device identification.

Specifically, in Embodiment 2, the to0d contains the device attribution information, the first nonce, and the push service timeout time, and the to1d contains the address of the push service.
Step 208: the authentication center determines whether the push service timeout time in the to0d is within a preset range; if yes, executes Step 209, otherwise, generates a new push service timeout time within the preset range, replaces the push service timeout time in the to0d with the new generated push service timeout time; and executes Step 209.
Step 209: the authentication center generates an identity authentication response according to the push service timeout time, and returns the identity authentication response to the push service.

For example, the identity authentication response in this step is:

[symbol]

“waitSeconds”: 14400 [symbol]
} [symbol] [symbol]
indicates data missing or illegible when filed

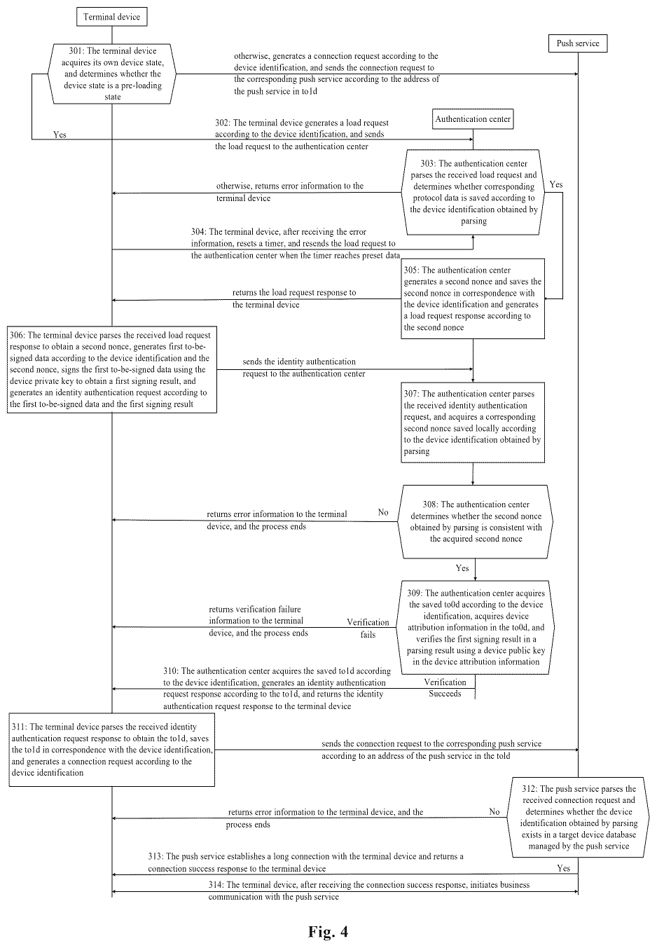

Step 210: the push service parses the received identity authentication response to obtain the push service timeout time, and saves the push service timeout time; the process ends.
The device registration process in Embodiment 2, as shown in FIG. 4, includes: Step 301: the terminal device acquires its own device state, and determines whether the device state is a pre-loading state (or status); if yes, executes Step 302, otherwise, generates a connection request according to the device identification, and sends the connection request to the corresponding push service according to the address of the push service in the to1d; executes Step 312.

Preferably, in Embodiment 2, before Step 301, the device registration process further includes: the terminal device burns an application, verifies the application, and boots up to initiate the application.

In Embodiment 2, the to1d is returned to the terminal device by the authentication center after the terminal device registers with the authentication center.
Step 302: the terminal device generates a loading request according to the device identification, and sends the loading request to the authentication center.
Step 303: the authentication center parses the received loading request, and determines whether corresponding protocol data is saved according to the device identification obtained by parsing; if yes, executes Step 305, otherwise; returns error information to the terminal device; executes Step 304.

Specifically, in Embodiment 2, the determining whether the corresponding protocol data is saved according to the device identification obtained by parsing includes: whether the to0d and the to1d are saved according to the device identification obtained by parsing is determined.
Step 304: the terminal device, after receiving the error information, resets a timer, resends the loading request to the authentication center when the timer reaches preset data, and returns to Step 303.
Step 305: the authentication center generates a second nonce and saves the second nonce in correspondence with the device identification, generates a loading request response according to the second nonce, and returns the loading request response to the terminal device.
Step 306: the terminal device parses the received loading request response to obtain a second nonce, generates first to-be-signed data according to the device identification (GUID) and the second nonce, signs the first to-be-signed data using the device private key to obtain a first signing result, generates an identity authentication request according to the first to-be-signed data and the first signing result, and sends the identity authentication request to the authentication center.

For example, the first to-be-signed data generated in Embodiment 2 is:

```

[symbol]

{ [symbol]
  “payload”: { [symbol]
        “nonceTO [symbol] Proof”:“202303112044037000001”, [symbol]
      “guid”:“102391944303101521000001” [symbol]
  }, [symbol]
    “protectedHeader”: “”, [symbol]
    “signature”: “Qizt0axf5/ [symbol] 6 [symbol] BG1xyH+Pt/oG [symbol] FaCbE [symbol] QvV+4EgMR0QVOKo8XOYdM6zOfa36/yHOv0BiCUXQPEQOUJ43j [symbol] QMg==”, [symbol]
    “tag”: “COSE_SIGN_1”, [symbol]
    “unprotectedHeader”: { } [symbol]
} [symbol] [symbol]
indicates data missing or illegible when filed
```

Step 307: the authentication center parses the received identity authentication request, and acquires a corresponding second nonce saved locally according to the device identification obtained by parsing.

Specifically, in Embodiment 2, in Step 307, the authentication center parses the identity authentication request to obtain first to-be-signed data and a first signing result, and parses the first to-be-signed data to obtain a device identification and a second nonce.
Step 308: the authentication center determines whether the second nonce obtained by parsing is consistent with the acquired second nonce; if yes, executes Step 309, otherwise, returns error information to the terminal device; the process ends.
Step 309: the authentication center acquires the saved to0d according to the device identification, acquires device attribution information in the to0d, and verifies the first signing result in a parsing result using a device public key in the device attribution information; if the verification succeeds, executes Step 310, if the verification fails, returns verification failure information to the terminal device; the process ends.

Specifically, in Step 309 of Embodiment 2, the verifying the first signing result in the parsing result using the device public key in the device attribution information includes: the first signing result in the parsing result is decrypted using the device public key in the device attribution information; a hash calculation is performed on the first to-be-signed data in the parsing result; whether a result obtained by decryption matches a result obtained by hash calculation is determined; if yes, the verification succeeds, otherwise the verification fails.
Step 310: the authentication center acquires the saved to1d according to the device identification, generates an identity authentication request response according to the to1d, and returns the identity authentication request response to the terminal device.
Step 311: the terminal device parses the received identity authentication request response to obtain the to1d, saves the to1d in correspondence with the device identification, generates a connection request according to the device identification, and sends the connection request to the corresponding push service according to an address of the push service in the to1d.
Step 312: the push service parses the received connection request, and determines whether the device identification obtained by parsing exists in a target device database managed by the push service; if yes, executes Step 313, otherwise, returns error information to the terminal device; the process ends.
Step 313: the push service establishes a long connection with the terminal device and returns a connection success response to the terminal device.
Step 314: the terminal device, after receiving the connection success response, initiates business communication with the push service.

In Embodiment 2, the terminal device, after successfully establishing a long connection with the push service, starts to send a business request to the push service.

A practical application of the present invention may be as follows: Manufacturer B produces terminal device A, and Enterprise C (which provides a push service) purchases terminal device A and SDK (Software Development Kit). The push service registers with an authentication center through SDK, and after push service registration is completed, the authentication center knows all terminal devices managed by the push service and saves device identifications of all the terminal devices. The manufacturer B supplies the terminal device A for use by customers of the enterprise C. When powered on, the terminal device automatically registers with the authentication center. The authentication center determines that the current terminal device identification is saved, and sends an address of the push service to which the current terminal device belongs to the current terminal device, and the current terminal device establishes a long connection with the corresponding push service using the address of the push service. After the customer obtains the terminal device A, the business processing is performed. The authentication center verifies the push service and the terminal device such that attackers are unable to acquire information about an IoT service provider to which the terminal device intends to connect, thereby ensuring the security of the IoT cloud service.

In Embodiment 2, after being powered on, the terminal device needs to undergo identity verification by the authentication center, and after the verification passes, the authentication center issues the address of the push service matched with the terminal identification to the device, and the device uses the address of the push service to ultimately realize the purpose of establishing a connection with the push service, and then performing the business processing.

The present invention also provides a system for implementing IoT registration, including: a push service, a terminal device and an authentication center, used for implementing the method for implementing the IoT registration disclosed in Embodiment 1 and Embodiment 2.

Preferably, the present invention also provides an electronic device, including at least one processor, a memory, and instructions stored on the memory and executable by the at least one processor. The at least one processor executes the instructions to implement the method for implementing the IoT registration in the above embodiments. The electronic device, when being a chip system, may be constituted by a chip, or may include a chip and other discrete devices, and the present invention is not particularly limited thereto. The chip is coupled to the memory for executing the computer program stored in the memory to perform the method for implementing the IoT registration disclosed in the above embodiments.

The above embodiments may be implemented, in whole or in part, by software, hardware, firmware, or any combination thereof. When implemented using a software program, it may be implemented in whole or in part in the form of a computer program product. The computer program product includes one or more computer programs. When the computer program is loaded and executed on an electronic device, the processes or functions of the present invention are produced in whole or in part. The computer program may be stored in a computer readable storage medium, or sent from one computer readable storage medium to another computer readable storage medium, for example, the computer instructions may be sent from one base station, electronic device, server, or data center to another base station, electronic device, server, or data center in a wired (e.g., coaxial cable, optical fiber, digital subscriber line (DSL)) manner or a wireless (e.g., infrared, radio, microwave, etc.) manner. The computer readable storage medium may be any available media that can be accessed by the electronic device or a data storage device including one or more servers, data centers, or the like that may be integrated with the media. The available media may be magnetic media (e.g., floppy disk, hard disk, magnetic tape), optical media (e.g., DVD), or semiconductor media [e.g., solid state disk (SSD)], etc.

Although the present invention has been described herein in conjunction with various embodiments, those skilled in the art may understand and implement other variations to the disclosed embodiments by reviewing the drawings, the disclosure, and the appended claims. In the claims, the word “comprising” does not exclude other elements or steps, and the word “a” or “an” does not exclude the possibility of plurality. A single processor or other units may implement multiple functions recited in the claims. The fact that certain measures are recited in mutually different dependent claims does not indicate that the combination of these measures cannot yield good effects.

Although the present invention has been described in conjunction with specific features and embodiments thereof, it will be apparent that various modifications and combinations can be made thereto without departing from the spirit and scope of the present invention. Accordingly, the description and drawings are merely exemplary illustrations of the present invention as defined by the appended claims, and are considered to cover any and all modifications, variations, combinations or equivalents that are within the scope of protection of the present invention.

1. A method for implementing an IoT registration, wherein the method comprises: a push service registration process and a terminal device registration process, the push service registration process comprises the following steps:
S1) generating, by a push service, a registration request according to a device identification of a terminal device that needs to be registered, corresponding device attribution information and a push service public key, and sending the registration request to an authentication center, the device attribution information comprising a device public key, identity information of the push service, and an address of the push service;
S2) saving, by the authentication center, the device identification, the corresponding device attribution information and the push service public key in the registration request received, generating a first nonce, generating a registration response according to the device identification in the registration request and the first nonce, and returning the registration response to the push service;
S3) parsing, by the push service, the registration response received, generating protocol data according to the device attribution information, the first nonce obtained by parsing, and preset push service timeout time, generating an identity authentication request according to the protocol data, and sending the identity authentication request to the authentication center;
S4) verifying, by the authentication center, the identity authentication request according to the push service public key, and saving the protocol data in the identity authentication request in correspondence with the device identification if a verification succeeds, then executing Step S5;
S5) determining, by the authentication center, whether the push service timeout time in the identity authentication request is within a preset range, if yes, executing Step S6, otherwise, generating another push service timeout time within the preset range, and replacing the push service timeout time in the protocol data with the another push service timeout time generated, then executing Step S6;
S6) generating, by the authentication center, an identity authentication response according to the push service timeout time and returning the identity authentication response to the push service; and
S7) saving, by the push service, the push service timeout time in the identity authentication response;
the terminal device registration process comprises the following steps:
T1) generating, by the terminal device, a loading request according to the device identification, and sending the loading request to the authentication center;
T2) determining, by the authentication center, whether corresponding protocol data is saved according to the device identification in the loading request, if yes, executing Step T3, otherwise, returning error information to the terminal device;
T3) generating, by the authentication center, a second nonce, saving the second nonce in correspondence with the device identification, generating a loading request response according to the second nonce, and returning the loading request response to the terminal device;
T4) parsing, by the terminal device, the loading request response received, generating an identity authentication request according to a second nonce obtained by parsing, the device identification and a device private key, and sending the identity authentication request to the authentication center;
T5) verifying, by the authentication center, the identity authentication request according to a device public key in the saved protocol data and the second nonce, if a verification succeeds, generating an identity authentication request response according to an address of the push service in the saved protocol data, and returning the identity authentication request response to the terminal device, then executing Step T6; if the verification fails, returning error information to the terminal device; and
T6) parsing, by the terminal device, the identity authentication request response to obtain the address of the push service, and saving the address of the push service in correspondence with the device identification.

2. The method according to claim 1, wherein before Step S1, the method further comprises: inquiring, by the push service, whether any terminal device that needs to be registered exists in a target device database managed by the push service, if yes, executing Step S1, otherwise, waiting to receive a terminal device connection request, the terminal device that needs to be registered comprising a terminal device that has not been connected to the push service, or a terminal device whose connection time with the push service exceeds the preset push service timeout time.

3. The method according to claim 1, wherein Step S3 comprises: parsing, by the push service, the registration response received so as to obtain the device identification and the first nonce, generating first protocol data according to device attribution information corresponding to the device identification, the first nonce, and preset push service timeout time; calculating a hash value of the first protocol data; generating valid data according to the hash value of the first protocol data and the address of the push service; signing the valid data using a push service private key to obtain signing data; generating second protocol data according to the valid data and the signing data; generating an identity authentication request according to the first protocol data and the second protocol data; and sending the identity authentication request to the authentication center.

4. The method according to claim 3, wherein Step S4 comprises:
S41) parsing, by the authentication center, the identity authentication request received so as to obtain the first protocol data and the second protocol data;
S42) performing, by the authentication center, a hash calculation on the first protocol data, and determining whether a calculated hash value is consistent with a hash value in the valid data of the second protocol data, if yes, executing Step S43, otherwise, returning error information to the push service, and ending the push service registration process;
S43) verifying, the authentication center, the signing data in the second protocol data using the push service public key saved, and determining whether a verification passes, if yes, executing Step S44, otherwise returning error information to the push service, and ending the push service registration process; and
S44) saving, by the authentication center, the first protocol data and the second protocol data in correspondence with the device identification.

5. The method according to claim 1, wherein before Step T1, the method further comprises: acquiring, by the terminal device, its own device state (or device status), and determining whether the device state is a pre-loading state, if yes, executing Step T1.

6. The method according to claim 1, wherein when it is determined in Step T2 that the result is no, the method further comprises: resetting, by the terminal device, a timer after receiving the error information, and resending the loading request to the authentication center when the timer reaches a preset value, then executing Step T2.

7. The method according to claim 1, wherein Step T4 comprises: parsing, by the terminal device, the loading request response received so as to obtain the second nonce, generating first to-be-signed data according to the device identification and the second nonce, signing the first to-be-signed data using the device private key to obtain a first signing result, generating an identity authentication request according to the first to-be-signed data and the first signing result, and sending the identity authentication request to the authentication center.

8. The method according to claim 7, wherein Step T5 comprises:
T51) parsing, by the authentication center, the identity authentication request received, and acquiring a corresponding second nonce saved according to the device identification obtained by parsing;
T52) determining, by the authentication center, whether the second nonce obtained by parsing is consistent with the acquired second nonce, if yes, executing Step T53, otherwise returning error information to the terminal device, and ending the terminal device registration process; and
T53) acquiring, by the authentication center, the protocol data saved according to the device identification; acquiring device attribution information in the protocol data; verifying the first signing result in a parsing result using the device public key in the device attribution information; executing Step T54 if a verification succeeds, returning error information to the terminal device if the verification fails, then ending the terminal device registration process;
T54) acquiring, by the authentication center, the address of the push service in the corresponding protocol data saved according to the device identification, generating an identity authentication request response according to the address of the push service, and returning the identity authentication request response to the terminal device.

9. The method according to claim 5, wherein after Step T6 or when the device state of the terminal device is not the pre-loading state, the method further comprises:
A1) generating, by the terminal device, a connection request according to the device identification, sending the connection request to a corresponding push service according to the address of the push service in the protocol data;
A2) parsing, by the push service, the connection request received, and determining whether the device identification obtained by parsing exists in a target device database managed by the push service, if yes, executing Step A3, otherwise returning error information to the terminal device, then ending the terminal device registration process;
A3) establishing, by the push service, a long connection with the terminal device; and returning a connection success response to the terminal device; and
A4) initiating, by the terminal device, business communication with the push service after receiving the connection success response.

10. A system for implementing an IoT registration, wherein the system comprises a push service, a terminal device, and an authentication center, and is used for implementing the method for implementing the IoT registration according to any one of claims 1 to 9.

11. An electronic device, a computer readable storage medium, or a chip system, wherein the electronic device comprises at least one processor, a memory, and instructions stored on the memory and executable by the at least one processor, the at least one processor executing the instructions to implement the method for implementing the IoT registration according to claim 1.

12. The electronic device, the computer readable storage medium, or the chip system according to claim 11, wherein the computer readable storage medium comprises a computer program that, when executed, implements the method for implementing the IoT registration according to claim 1.

13. The electronic device, the computer readable storage medium, or the chip system according to claim 11, wherein the chip system comprises a chip coupled to a memory for executing a computer program stored in the memory to perform the method for implementing the IoT registration according to claim 1.
